(19) United States
(12) Patent Application Publication
(10) Pub. No.: US 2015/0040750 A1
(43) Pub. Date: Feb. 12, 2015

(54) REACTION ROD RETAINER FOR VACUUM BOOSTER AND METHOD FOR RETAINING REACITON ROD

(71) Applicant: BWI (Shanghai) Co., Ltd., Shanghai (CN)

(72) Inventors: Dongqiang Luo, Shanghai (CN); Mingfang Xu, Shanghai (CN)

(21) Appl. No.: 14/451,883

(22) Filed: Aug. 5, 2014

(30) Foreign Application Priority Data
Aug. 7, 2013 (CN) 201310341553.9

(51) Int. Cl. B60T 13/569

(52) U.S. Cl. CPC B60T 13/569
USPC 91/368; 29/888.02

(57) ABSTRACT

A reaction rod retainer for vacuum booster and a method for retaining a reaction rod, the reaction rod retainer for vacuum booster comprising a hollow annular body, wherein a plurality of outer ribs extend radially outwardly from an outer edge of the body, and wherein a plurality of inner ribs extend radially inwardly from an inner edge of said body. The reaction rod retainer guarantees tightness and firmness of combination of the reaction rod and feedback plate, in addition, it has an advantage of simple structure and meanwhile reduces the cost. The method for retaining reaction rod provided also has advantages of simple assembly and being easy to assemble.

### CROSS REFERENCE TO RELATED APPLICATION

The subject application claims priority to CN patent application 201310341553.9 tiled on Aug. 7, 2013, the entire disclosure of which is incorporated herein by reference.

### FIELD OF INVENTION

The intention relates to a vacuum booster, in particular to a reaction rod retainer for vacuum booster and a method for retaining reaction rod.

### BACKGROUND OF THE INVENTION

As is well known, at present in automobile braking system, a vacuum booster is often adopted to achieve a boosting for braking, Main principle adopted is to realize the effect of boosting by using pressure difference between vacuum and atmosphere. A conventional vacuum booster mainly comprises components including a front and rear shell assembly, a control valve body, an air valve, a feedback plate, a reaction rod, etc. A base of the reaction rod and the feedback plate tightly press the reaction rod retainer by elastic force of a return spring, so that the reaction rod and the feedback plate are kept to be pressed tightly and fixed. However, the above connection structure has defects such as complex structure, higher cost, etc.

In light of numerous defects of the above conventional reaction rod retainer, based on many years of research as well as on-site experience and professional knowledge, the inventor positively make improvement and innovation by combining actual using condition and structural technique demand, attempting to realize a reaction rod retainer for vacuum booster and a method for retaining reaction rod which can not only meet the requirement of combing the reaction rod and the feedback plate, but also simplify structure and lower cost.

### SUMMARY OF THE INVENTION

The invention is aimed to provide a reaction rod retainer for vacuum booster which can not only meet the requirement of combining the reaction rod and the feedback plate, but also simplify structure and lower cost.

Besides, the invention is aimed to provide a method for retaining reaction rod in which the above reaction rod retainer for vacuum booster is used.

To achieve the above purposes, the invention provides a reaction rod retainer for vacuum booster, comprising a hollow annular body, wherein a plurality of outer ribs extend radially outwardly from an outer edge of said body, and a plurality of inner ribs extend radially inwardly from an inner edge of said body.

The reaction rod retainer for vacuum booster as mentioned above, wherein said plurality of outer ribs have a same length and said plurality of inner ribs have a same length.

The reaction rod retainer for vacuum booster as mentioned above, wherein said outer ribs and said inner ribs are evenly distributed along the circumferential direction.

The reaction rod retainer for vacuum booster as mentioned above, wherein said outer ribs are easy to bend.

The invention further provides a method for retaining reaction rod, in which the above-mentioned reaction rod retainer for vacuum booster is adopted, wherein said method for retaining reaction rod comprising the following steps:

fitting said retainer on the reaction rod of the vacuum booster, so that the inner ribs of said retainer are pressed on a stepped surface of an outer periphery of a base of said reaction rod;

bending the outer ribs of said retainer towards a side of a control valve body of said vacuum booster, so that said outer ribs are buckled in a side wall of said control valve body. The invention has the following features and advantages over the prior art:

1. With the force of the combination of the reaction rod retainer of the invention with the control valve body, the inner ribs of the retainer are tightly pressed against the reaction rod to realize that the reaction rod is kept abutting against the feedback plate, so as to achieve the effect of retention. The reaction rod retainer of the invention guarantees tightness and firmness of combination of the reaction rod and feedback plate; in addition, it has an advantage of simple structure and meanwhile reduces the cost.

2. The method for retaining reaction rod provided by the invention has advantages of simple assembly and being easy to assemble.

### BRIEF DESCRIPTION OF THE DRAWINGS

The accompanying drawings described here are merely for the sake of explanation, but with on intention to limit the scope disclosed by the invention in any way. In addition, shape and proportional dimensions of the components in the drawings are only exemplary and used for helping understanding to the invention, but not specifically defining the shape and proportional dimensions of the components of the invention. Under the teaching of the invention, persons skilled in the art can implement the invention by selecting various possible shape and proportional dimensions depending on specific circumstances.

FIG. 1 is a structural schematic of the reaction rod retainer for vacuum booster of the invention;

FIG. 2 is a perspective structure schematic when the ruction rod retainer for vacuum booster of the invention is installed on the vacuum booster;

FIG. 3 is a side-view structural schematic when the reaction rod retainer for vacuum booster of the invention is installed on the vacuum booster;

FIG. 4 is a sectional structure schematic taken along A-A.

### DETAILED DESCRIPTION OF THE EMBODIMENTS

The accompanying drawings and the description of the detailed description of the embodiments of the invention can be incorporated to understand details of the invention more clearly. However, the detailed embodiments of the invention described here are only used for explaining purposes of the invention, but can not be understood as limitation to the invention in any way. Under the teaching of the invention, persons skilled in the art can conceive that any possible deformations based on the invention should be regarded as belonging to the scope of the invention.

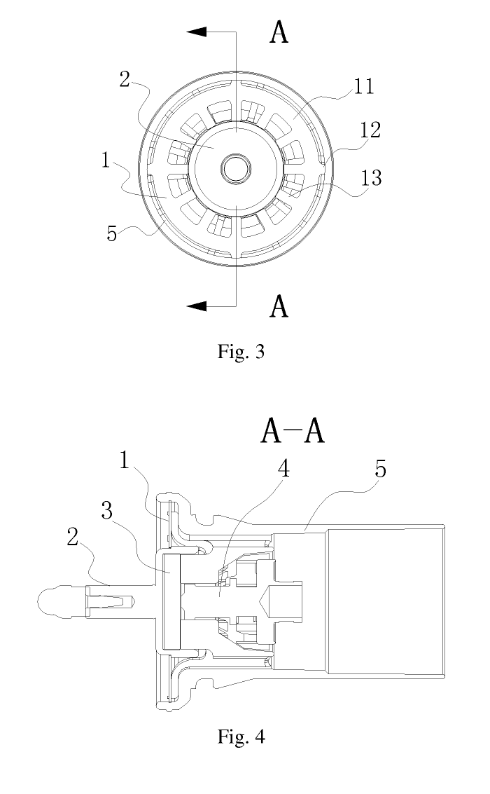

FIGS. 1 to 4 are a structural schematic of the reaction rod retainer for vacuum booster of the invention; a perspective structure schematic when the reaction rod retainer for vacuum booster of the invention is installed on the vacuum booster; a side-view structural schematic when the reaction rod retainer for vacuum booster of the invention is installed on the vacuum booster; and a sectional structure schematic taken along A-A, respectively.

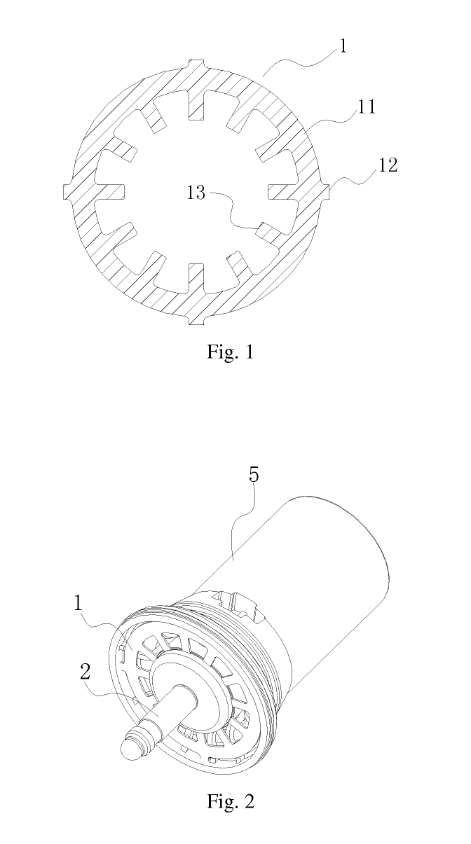

As shown in FIG. 1, the reaction rod retainer for vacuum booster 1 provided by the invention is used for a vacuum booster which comprises a control valve body 5, an air valve 4, a feedback plate 3 and a reaction rod 2 (as shown in FIGS. 2 to 4), wherein the reaction rod retainer for vacuum booster 1 is installed between the reaction rod 2 and the control valve body 5 for tightly pressing the reaction rod 2, such that the reaction rod 2 and the feedback plate 3 are combined tightly together. The reaction rod retainer for vacuum booster 1 comprises a hollow annular body 11, wherein a plurality of outer ribs 12 extend radially outwardly from an outer edge of said body 11, and a plurality of inner ribs 13 extend radially inwardly from an inner edge of said body 11. As shown in FIGS. 2 to 4, the inner ribs 13 are pressed on stepped surface of an outer periphery of a base of the reaction rod 2 of the vacuum booster, the outer ribs 12 are exactly buckled in a side wall of the control valve body 5 of the vacuum booster by bending, such that the retainer is tightly pressed against the reaction rod 2, thereby keeping tight combination of the reaction rod 2 and the feedback plate 3. In this way, the invention guarantees tightness and firmness of combination of the reaction rod 2 and feedback plate 3, in addition, it has an advantage of simple structure and meanwhile reduces the cost.

Furthermore, as shown in FIG. 1, the outer ribs 12 have a same length, and the inner ribs 13 have a same length for the convenience of installation. The outer ribs 12 or the inner ribs 13 can certainly have different length only if it can play the function of retention.

Furthermore, as shown in FIG. 1, the outer ribs 12 and the inner ribs 13 are evenly distributed along the circumferential direction, such that pressure from the reaction rod retainer 1 to the reaction rod 2 is kept to be even, which helps to maintain a stable state of retention.

In this embodiment, the outer ribs 12 are made of material which is easy to bend, such as steel etc.

As shown in FIGS. 2 to 4, the invention further provides a method for retaining reaction rod, in which the above-mentioned reaction rod retainer for vacuum booster is adopted, wherein the method for retaining reaction rod comprising the following steps:

firstly, sleeving the retainer 1 on the reaction rod 2 of the vacuum booster, such that the inner ribs 13 of the retainer 1 are pressed on stepped surface of an outer periphery of a base of the reaction rod 2 (as shown in FIG. 4); next, bending the outer ribs 12 of the retainer 1 towards a side of the control valve body 5 of the vacuum booster, so that the outer ribs 12 are buckled in a side wall of the control valve body 5. In this way, under the effect of the combined force of the outer ribs 12 and the control valve body 5, the inner ribs 13 of the retainer 1 are tightly pressed against the base of the reaction rod 12, so that the reaction rod 2 is kept abutting against the feedback plate 3, so as to achieve the effect of retention. The method for retaining reaction rod of the invention has advantages of simple assembly and being easy to assemble, when compared with the structure of the prior art in which a return spring is adopted.

The detailed explanations to the above embodiments are aimed only to explain the invention, so as to better understand the invention, however, the description can not be interpreted as limitation to the invention for whatever reason, and in particular, the features described in different embodiments can be combined with any one another to form other embodiments, except for explicitly opposite description, these features should be understood as being capable to be applied into any embodiment, rather than being only limited to the described embodiment.

What is claimed is:

1. A reaction rod retainer for vacuum booster, comprising a hollow annular body, wherein a plurality of outer ribs extend radially outwardly from an outer edge of said body, and a plurality of inner ribs extend radially inwardly from an inner edge of said body.

2. The reaction rod retainer for vacuum booster according to claim 1, wherein said plurality of outer ribs have a same length and said plurality of inner ribs have a same length.

3. The reaction rod retainer for vacuum booster according to claim 1, wherein said outer ribs and said inner ribs are evenly distributed along the circumferential direction thereof.

4. The reaction rod retainer for vacuum booster according to claim 1, wherein said outer ribs are easy to bend.

5. A method of retaining reaction rod for vacuum booster comprising: fitting a retainer on the reaction rod of the vacuum booster, so that the inner ribs of the retainer are pressed on a stepped surface of an outer periphery of a base of the reaction rod;
bending the outer ribs of the retainer towards a side of a control valve body of the vacuum booster, so that said outer ribs are buckled in a side wall of the control valve body.
